(19) United States
(12) Patent Application Publication
(10) Pub. No.: US 2014/0045030 A1
(43) Pub. Date: Feb. 13, 2014

(54) METHOD FOR FORMING AN ELECTROCHEMICAL CELL, AN ELECTROCHEMICAL CELL AND BATTERY

(71) Applicant: Li-Tec Battery GmbH, Kamenz (DE)

(72) Inventors: Tim Schaefer, Harztor (DE); Magnus Mickel, Wittichenau (DE); Markus Wohnig, Dresden (DE); Iris Stiebert, Dresden (DE)

(73) Assignee: Li-Tec Battery GmbH, Kamenz (DE)

(21) Appl. No.: 13/961,278

(22) Filed: Aug. 7, 2013

Related U.S. Application Data
(60) Provisional application No. 61/680,315, filed on Aug. 7, 2012.

(30) Foreign Application Priority Data
Aug. 7, 2012 (DE) 10 2012 015 575.1
Sep. 10, 2012 (DE) 10 2012 017 829.8

(51) Int. Cl. H01M 10/04

(52) U.S. Cl. CPC H01M 10/0413
USPC 429/122; 29/623.1; 29/593

(57) ABSTRACT

A method for forming an electrochemical cell comprising a first connector and a second connector for a battery preferably designed for use in motor vehicles which employs a forming unit comprising a first contact element and a second contact element, wherein the first connector comprises a first formation contact section designed to be disconnectable and the second connector comprises a second formation contact section designed to be disconnectable, comprising the steps of: (S1a) pressing the first contact element of the forming unit against the first formation contact section of the first connector, (S1b) pressing the second contact element of the forming unit against the second formation contact section of the second connector, (S5) implementing a forming treatment, (S6a) separating the first formation contact section from the first connector, and (S6b) separating the second formation contact section from the second connector.

### CROSS-REFERENCE TO RELATED APPLICATIONS

The present application claims the benefit of U.S. Provisional Patent Application Ser. No. 61/680,315, filed on Aug. 7, 2012, the entire content of which is incorporated herein by reference. The present application also claims priority to German patent application number DE 10 2012 015 575.1, filed on Aug. 7, 2012, the entire content of which is incorporated herein by reference, and German patent application number DE 10 2012 017 829.8, filed on Sep. 10, 2012, the entire content of which is incorporated herein by reference.

### DESCRIPTION

The present invention relates to a method for forming an electrochemical cell preferably for a battery preferably designed for use in motor vehicles as well as correspondingly formed electrochemical cells and a battery comprising said electrochemical cells.

It is known in the manufacture of electrochemical cells to subject the cells to a formation process for the purpose of improving their properties. The forming includes a preferably repeated charging and discharging of the electrochemical cells. Different methods of forming electrochemical cells as well as the correspondingly formed electrochemical cells and batteries comprising said electrochemical cells are known from the prior art. Improved methods for forming electrochemical cells are desirable, particularly for use in motor vehicles.

The objective of the present invention is based on an improved method of forming electrochemical cells as well as providing correspondingly formed electrochemical cells or batteries respectively.

This objective is accomplished by a method for forming electrochemical cells in accordance with claim 1, an electrochemical cell in accordance with claim 10, as well as a battery in accordance with claim 12. Preferential further developments of the invention constitute the subject matter of the subclaims.

This objective is accomplished by a method for forming an electrochemical cell comprising a first connector and a second connector for a battery preferably designed for use in motor vehicles which employs a forming unit comprising a first contact element and a second contact element, wherein the first connector comprises a first formation contact section designed so as to be disconnectable and the second connector comprises a second formation contact section designed so as to be disconnectable, in that the method comprises the following steps: a step of pressing the first contact element of the forming unit against the first formation contact section of the first connector, a step of pressing the second contact element of the forming unit against the second formation contact section of the second connector, a forming treatment step, a step of separating the first formation contact section from the first connector and a step of separating the second formation contact section from the second connector. One advantage of this design is being able to improve the contact between the forming unit and the electrochemical cell and, as a result, its formation. Another advantage to this design is being able to accelerate the formation process since—without negatively impacting the final state of the first connector or the final state of the second connector—the formation contact sections can be subjected to higher charges as needed during the formation process.

In the terms of the present invention, an electrochemical cell is to be understood as an electrochemical energy store; i.e. a device which stores energy in chemical form, releases it to a load in electrical form, and preferably can also absorb it in electrical form from a charging device. Important examples of such electro-chemical energy stores are galvanic cells or fuel cells. The electrochemical cell comprises at least one first and one second device for storing electrically different charges, same being configured as an electrode assembly, as well as a means for establishing an operative electrical connection between the two said devices, wherein charge carriers can be positioned between the two said devices. For example, an electrolyte acting as an ion connector can be understood as the means for establishing an operative electrical connection.

The method step of pressing the first contact element is preferably performed so as to penetrate the surface layers of the first formation contact section. The method step of pressing the second contact element is moreover preferably performed so as to penetrate surface layers of the second formation contact section. One advantage of this design is reducing the contact resistance, with the contact and formation being improved as a result.

It is preferable in the method for the first contact element of the forming unit to comprise at least one tip. Furthermore, the second contact element of the forming unit preferably comprises at least one tip in the method. One advantage of this design is being able to improve the contact in particularly easy manner.

In the method, the first contact element is preferably configured as a first number of first contact pins, wherein it is particularly preferable for the first contact element to comprise three first contact pins. In accordance with a further preferred embodiment, the first contact element comprises only one first contact pin. Furthermore, the second contact element in the method is preferably configured as a second number of second contact pins, wherein it is particularly preferable for the second contact element to comprise three second contact pins. In accordance with a further preferred embodiment, the second contact element comprises only one second contact pin.

It is preferable in the method for the first contact pins to be individually supported. It is furthermore preferable in the method for the second contact pins to be individually supported. One advantage of this design is being able to particularly readily adapt the pressure so as to further reduce the contact resistance.

It is preferable in the method for the first contact element to comprise at least one cap having a contact spike on its contacting end, wherein it is particularly preferential for the first contact element to comprise three caps with preferably four contact spikes. It is further preferable for the second contact element to comprise at least one cap on its contacting end having a contact spike, wherein it is particularly preferential for the second contact element to comprise three caps with preferably four contact spikes. One advantage of this design lies in being able to particularly easily improve the effective contact.

Subsequent the step of pressing the first contact element, the method preferably comprises the following further steps: a step of detecting first parameter data from the first contact of the first contact element of the forming unit to the first formation contact section of the first connector, a step of supplying the detected first parameter data to a controller, and a step of performing a first change in the contact as a function of the detected first parameter data when the detected first parameter data exhibits a predefined first threshold.

Subsequent the step of pressing the second contact element, the method further preferably comprises the following further steps: a step of detecting second parameter data from the second contact of the second contact element of the forming unit to the second formation contact section of the second connector, a step of supplying the detected second parameter data to a controller, and a step of performing a second change in the contact as a function of the detected second parameter data when the detected second parameter data exhibits a predefined second threshold. One advantage of this design is being able to easily maintain the desired contact properties during the formation.

The method step of detecting first parameter contact data preferably comprises at least one of the following steps: a step of detecting a first contact resistance of the first contact of the forming unit's first contact element to the first connector's first formation contact section and/or a step of detecting a first temperature of the first contact of the forming unit's first contact element to the first connector's first formation contact section. It is furthermore preferential for the method step of detecting second parameter contact data to comprise at least one of the following steps: a step of detecting a second contact resistance of the second contact of the forming unit's second contact element to the second connector's second formation contact section and/or a step of detecting a second temperature of the second contact of the forming unit's second contact element to the second connector's second formation contact section.

The method step of performing a first contact change preferably comprises the following step: a step of increasing a first pressure with which the first contact element is pressed against the first connector's first formation contact section. Furthermore, the method step of performing a second contact change preferably comprises the following step: a step of increasing a second pressure with which the second contact element is pressed against the second connector's second formation contact section.

The method step of realizing formation preferably comprises the following steps: a step of realizing a first forming of the electrochemical cell in a range of 25-40% of nominal capacity, a step of realizing a second forming of the electrochemical cell in a range of 75-90% of nominal capacity, and a step of realizing a third forming of the electrochemical cell to 100% nominal capacity. One advantage of this design is being able to increase the capacity of the formatted electrochemical cell.

The objective is furthermore accomplished by means of an electrochemical cell having a first connector comprising a first formation contact section designed so as to be disconnectable and a second connector comprising a second formation contact section designed so as to be disconnectable, with the electrochemical cell having been formed by means of one of the above-described methods.

The first formation contact section for the electrochemical cell is preferably arranged on an outer end of the first connector. Furthermore, the second formation contact section is preferably arranged on an outer end of the second connector. One advantage of this design is being able to better realize the separating of the first formation contact section from the first connector, or the separation of the second formation contact section from the second connector respectively, following formation.

The objective is furthermore accomplished by means of a battery comprising an electrochemical cell, with the electrochemical cell of the battery having been formed by means of one of the above-described methods.

The following will draw on preferential embodiments referencing the figures to describe aspects of the invention in greater detail. Shown are:

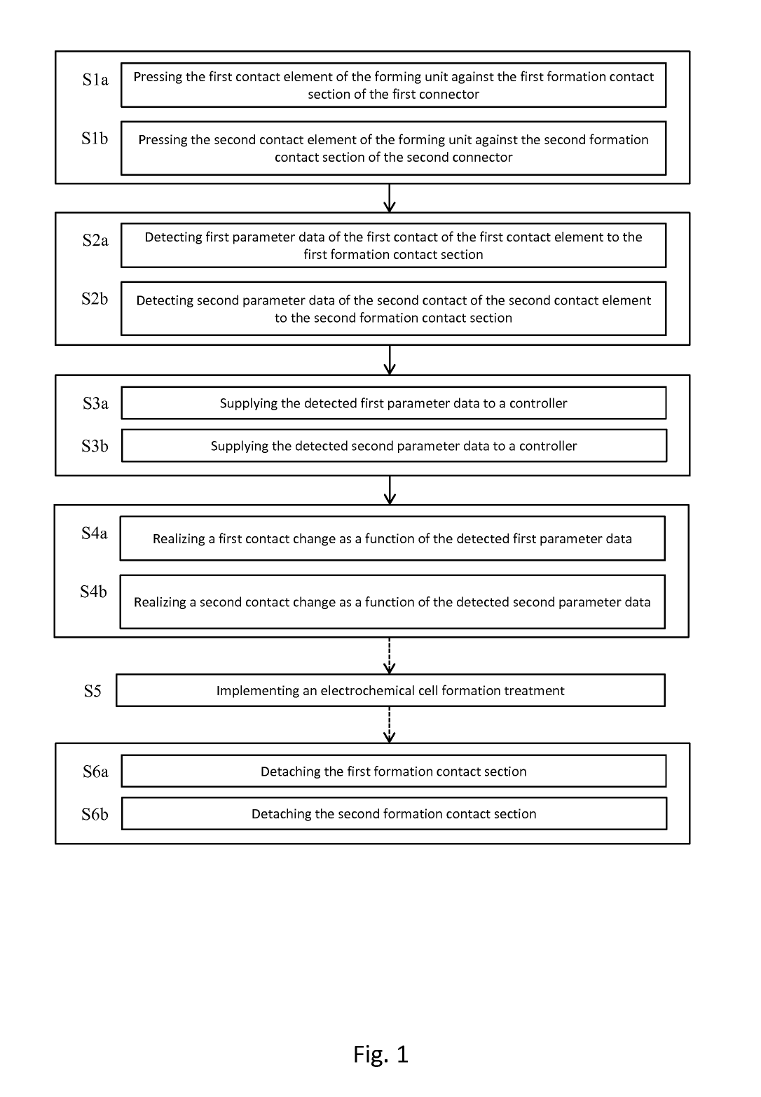

FIG. 1 a flow chart of a method for forming electrochemical cells according to one embodiment,

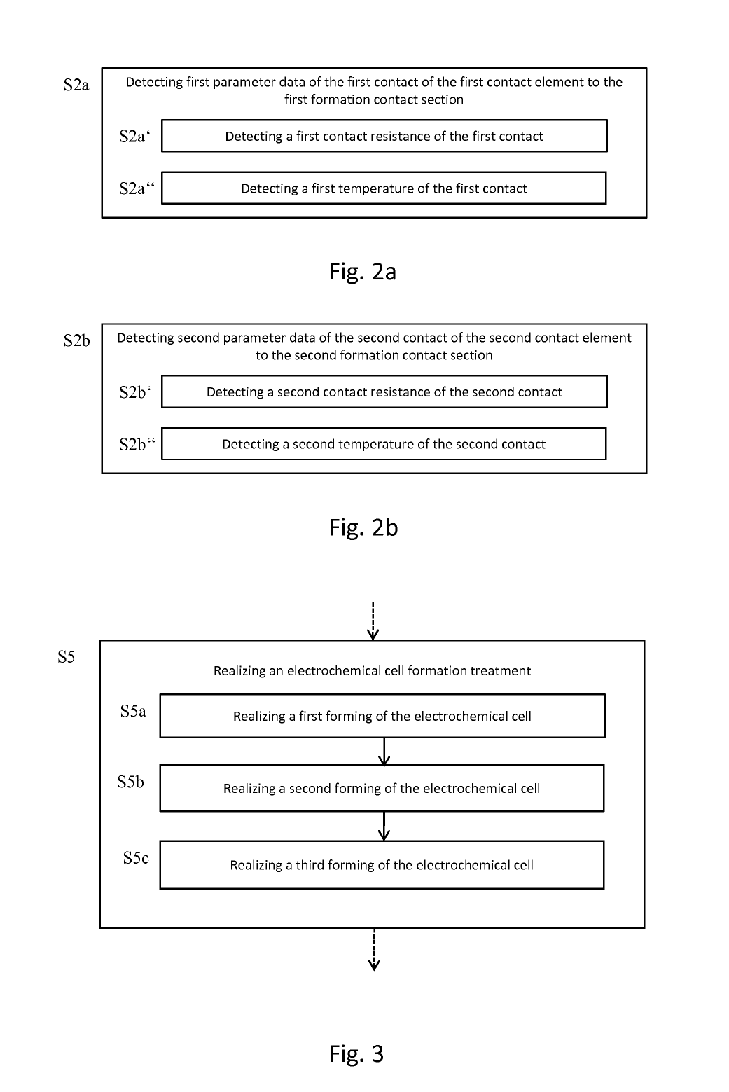

FIG. 2a a first detailed depiction of the flow chart shown in FIG. 1 with respect to the detecting of first parameter data,

FIG. 2b a second detailed depiction of the flow chart shown in FIG. 1 with respect to the detecting of second parameter data, and

FIG. 3 a third detailed depiction of the flow chart shown in FIG. 1 with respect to realizing a forming treatment in accordance with a preferential embodiment.

FIG. 1 shows a flow chart for a method for forming an electrochemical cell according to one embodiment of the present invention. The electrochemical cell comprises a first connector having a first formation contact section and a second connector having a second formation contact section. The forming unit comprises a first contact element for the first connector's first formation contact section and a second contact element for the second connector's second formation contact section.

In step S1a, the first contact element of the forming unit is pressed against the first formation contact section of the first connector. In step S1b, the second contact element of the forming unit is pressed against the second formation contact section of the second connector, whereby steps S1a and S1b can be performed simultaneously or in a freely selectable sequence relative each other.

In accordance with one preferential embodiment, first parameter data of the first contact between the first contact element of the forming unit and the first formation contact section of the first connector is detected in step S2a.

As can be recognized from FIG. 2a, step S2a of detecting the first parameter data can include a step 2a′ of detecting a first contact resistance of the first contact between the first contact element of the forming unit and the first formation contact section of the first connector and/or a step 2a″ of detecting a first temperature of the first contact between the first contact element of the forming unit and the first formation contact section of the first connector.

According to the preferred embodiment, second parameter data of the second contact between the second contact element of the forming unit and the second formation contact section of the second connector can furthermore be detected in a step 2b, whereby steps S2a and S2b can be performed simultaneously or in a freely selectable sequence relative each other.

As can be recognized from FIG. 2b, step S2b of detecting the second parameter data can include a step 2b′ of detecting a second contact resistance of the second contact between the second contact element of the forming unit and the second formation contact section of the second connector and/or a step 2b″ of detecting a second temperature of the second contact between the second contact element of the forming unit and the second formation contact section of the second connector.

As can be further recognized from FIG. 1, in one preferred embodiment, the detected first parameter data can be supplied to a controller in a step S3a and the detected second parameter data can be supplied to a controller in a step S3b, whereby steps S3a and S3b can be performed simultaneously or in a freely selectable sequence relative each other.

In these embodiments, a change can be made to the first contact as a function of the detected first parameter data in a step S4a when the detected first parameter data exhibits a predefined first threshold. Furthermore, in a step S4b, a change can be made to the second contact as a function of the detected second parameter data when the detected second parameter data exhibits a predefined second threshold, whereby steps S4a and S4b can be performed simultaneously or in a freely selectable sequence relative each other.

In accordance with one embodiment not depicted in the figures, step S4a of realizing a change to the first contact can include a step S4a′ of increasing a first pressure with which the first contact element is pressed against the first formation contact section of the first connector. Step S4b of realizing a change to the second contact can furthermore comprise a step S4b′ of increasing a second pressure with which the second contact element is pressed against the second formation contact section of the second connector.

FIG. 1 shows that in the method according to the present invention, a forming treatment of the electrochemical cell is performed in a step S5 and FIG. 3 shows a flow chart of a preferred embodiment for realizing the forming treatment of electrochemical cells. In a step S5a, a first forming of the electrochemical cell is performed, preferably in a range of 25-40% of nominal capacity, and in a step S5b, a second forming of the electrochemical cell is performed, preferably in a range of 75-90% of nominal capacity, and in a step S5c, a third forming of the intermediate electrochemical cell product is performed, preferably to 100% nominal capacity.

In the method according to the present invention, after step S5 of realizing a forming treatment of the electrochemical cell, the first formation contact section is detached in step S6a and the second formation contact section is detached in step S6b, whereby steps S6a and S6b can be performed simultaneously or in a freely selectable sequence relative each other.

### LIST OF REFERENCE NUMERALS

S1a pressing the first contact element of the forming unit against the first formation contact section of the first connector
S1b pressing the second contact element of the forming unit against the second formation contact section of the second connector
S2a detecting first parameter data of the first contact between the first contact element of the forming unit and the first formation contact section of the first connector
S2a′ detecting a first contact resistance between the first contact of the first contact element of the forming unit and the first formation contact section of the first connector
S2a″ detecting a first temperature of the first contact between the first contact element of the forming unit and the first formation contact section of the first connector
S2b detecting second parameter data of the second contact between the second contact element of the forming unit and the second formation contact section of the second connector
S2b′ detecting a second contact resistance between the second contact of the second contact element of the forming unit and the second formation contact section of the second connector
S2b″ detecting a second temperature of the second contact between the second contact element of the forming unit and the second formation contact section of the second connector
S3a supplying the detected first parameter data to a controller
S3b supplying the detected second parameter data to a controller
S4a realizing a first change in the contact as a function of the detected first parameter data when the detected first parameter data exhibits a predefined first threshold
S4a′ increasing a first pressure with which the first contact element is pressed against the first formation contact section of the first connector
S4b realizing a second change in the contact as a function of the detected second parameter data when the detected second parameter data exhibits a predefined second threshold
S4b′ increasing a second pressure with which the second contact element is pressed against the second formation contact section of the second connector
S5 realizing a formation treatment
S5a realizing a first forming of the electrochemical cell in a range of 25-40% of nominal capacity
S5b realizing a second forming of the electrochemical cell in a range of 75-90% of nominal capacity
S5c realizing a third forming of the electrochemical cell to 100% nominal capacity
S6a detaching the first formation contact section
S6b detaching the second formation contact section

1-13. (canceled)

14. A method for forming an electrochemical cell comprising a first connector and a second connector for a battery preferably designed for use in motor vehicles which employs a forming unit comprising a first contact element and a second contact element, wherein the first connector comprises a first formation contact section designed so as to be disconnectable and the second connector comprises a second formation contact section designed so as to be disconnectable, the method comprising:
(S1a) pressing the first contact element of the forming unit against the first formation contact section of the first connector;
(S1b) pressing the second contact element of the forming unit against the second formation contact section of the second connector;
(S5) implementing a forming treatment;
(S6a) separating the first formation contact section from the first connector; and
(S6b) separating the second formation contact section from the second connector.

15. The method according to claim 14, wherein the step (S1a) of pressing the first contact element is realized so as to penetrate the surface layers of the first formation contact section and/or that the step (S1b) of pressing the second contact element is realized so as to penetrate surface layers of the second formation contact section.

16. The method according to claim 15, wherein the first contact element of the forming unit comprises at least one tip and the second contact element of the forming unit comprises at least one tip.

17. The method according to claim 16, wherein the first contact element is configured as a first plurality of first contact pins and/or the second contact element is configured as a second plurality of second contact pins.

18. The method according to claim 17, wherein the first contact pins are individually supported and/or the second contact pins are individually supported.

19. The method according to claim 16, wherein the first contact element comprises at least one cap having a contact spike on its contacting end and/or the second contact element comprises at least one cap having a contact spike on its contacting end.

20. The method according to claim 14, further comprising the following steps subsequent to the step (S1a) of pressing the first contact element:
(S2a) detecting first parameter data from the first contact of the first contact element of the forming unit to the first formation contact section of the first connector;
(S3a) supplying the detected first parameter data to a controller; and
(S4a) realizing a first change in the contact as a function of the detected first parameter data when the detected first parameter data exhibits a predefined first threshold

21. The method according to claim 20, wherein the step (S2a) of detecting first parameter data on the contact comprises at least one of the following steps:
(S2a′) detecting a first contact resistance of the first contact of the first contact element of the forming unit to the first formation contact section of the first connector, and/or
(S2a″) detecting a first temperature of the first contact of the first contact element of the forming unit to the first formation contact section of the first connector.

22. The method according to claim 20, wherein the step (S4a) of realizing a first contact change comprises:
(S4a′) increasing a first pressure with which the first contact element is pressed against the first formation contact section of the first connector.

23. The method according to claim 14, further comprising the following steps subsequent to the step (S1b) of pressing the second contact element:
(S2b) detecting second parameter data from the second contact of the second contact element of the forming unit to the second formation contact section of the second connector,
(S3b) supplying the detected second parameter data to a controller, and
(S4b) realizing a second change in the contact as a function of the detected second parameter data when the detected second parameter data exhibits a predefined second threshold.

24. The method according to claim 23, wherein the step (S2b) of detecting second parameter data on the contact comprises at least one of the following steps:
(S2b′) detecting a second contact resistance of the second contact of the second contact element of the forming unit to the second formation contact section of the second connector, and/or
(S2b″) detecting a second temperature of the second contact of the second contact element of the forming unit to the second formation contact section of the second connector.

25. The method according to claim 23, wherein the step (S4b) of realizing a second contact change comprises:
(S4b′) increasing a second pressure with which the second contact element is pressed against the second formation contact section of the second connector.

26. The method according to claim 14, wherein the step (S5) of realizing a formation treatment comprises:
(S5a) realizing a first forming of the electrochemical cell in a nominal capacity range of 25-40%,
(S5b) realizing a second forming of the electrochemical cell in a nominal capacity range of 75-90%, and
(S5b) realizing a third forming of the electrochemical cell to 100% nominal capacity.

27. An electrochemical cell, comprising:
a first connector comprising a first formation contact section configured to be disconnectable and a second connector comprising a second formation contact section configured to be disconnectable, wherein the electrochemical cell has been formed using the method according to claim 14.

28. The electrochemical cell according to claim 27, wherein the first formation contact section is arranged on an outer end of the first connector and/or the second formation contact section is arranged on an outer end of the second connector.

29. A battery comprising:
at least one electrochemical cell formed according to the method of claim 14.
